(19) United States
(12) Patent Application Publication
(10) Pub. No.: US 2017/0306874 A1
(43) Pub. Date: Oct. 26, 2017

(54) VEHICLE DRIVER MODEL

(71) Applicant: FORD GLOBAL TECHNOLOGIES, LLC, Dearborn, MI (US)

(72) Inventors: GUANG WU, WINDSOR (CA); HUGH O. FADER, ROYAL OAK, MI (US); LAWRENCE M. ROSE, BERKLEY, MI (US)

(21) Appl. No.: 15/134,443

(22) Filed: Apr. 21, 2016

(51) Int. Cl. F02D 41/10; G07C 5/02

(52) U.S. Cl. CPC F02D 41/107; G07C 5/02; B60W 2520/10; B60W 2520/105

(57) ABSTRACT

A method of testing an automotive vehicle estimates acceleration for multiple time windows. Each of the time windows has a different length. A speed of the vehicle is measured. The acceleration vector is estimated, for the time windows, as a function of the speed and a test speed. A target acceleration is calculated by multiplying the acceleration vector by a driving mode vector. A target speed, of a driver model, is set as a function of a test cycle, the target acceleration, and the speed. The vehicle is controlled at the target speed.

### BACKGROUND OF INVENTION

The present invention relates to automotive vehicle testing and in particular to a vehicle driver model for use in automotive vehicle testing.

Standard government test cycles for vehicle fuel economy and emissions may be performed for a vehicle on a chassis dynamometer, a powertrain dynamometer, or in a computer simulation. During the test cycle, a speed profile of the vehicle is maintained within specified tolerances. The fuel economy reported by the test cycle is heavily influenced by driver behavior. As such, it is desirable to have an automated driver that behaves consistently and in a similar manner to an expert human driver in terms of acceleration, speed, distance, and standard energy based fuel economy testing metrics such as energy economy rating (EER). The automated driver operates according to a driver model.

The driver model includes speed control. The speed control may use a combination of feedforward and feedback control. The feedforward control may use a time mapping window based on historical vehicle data. Generally, the feedforward control is a greater contributor to speed control than the feedback control and the feedback control simply adjusts an output of the feedforward control. Target acceleration is an input to the feedforward control. Thus, accuracy when calculating the target acceleration is important for an effective feedforward control and speed control, and for the driver model to comply with the test cycle.

However, the target acceleration is calculated for only a single look-ahead time window with constant time length. As a result, the driver model is not able to prepare for a fast change of target speed or predict a change of trend of the target speed. This is because only instantaneous change (less than 1 second ahead) is considered and any longer term trend (2-5 seconds) of the test cycle is ignored. Furthermore, tuning the map for use with a target acceleration determined for only a single time window with constant time length may require extensive work and the driver model may not behave well in vehicle launch, stop, and speed bungee—i.e., where speed goes to near zero and rebounds—driving scenarios.

### SUMMARY OF INVENTION

An embodiment contemplates a method of testing an automotive vehicle. A vehicle signal is estimated, a control parameter of a driver model for the vehicle is set, and a powertrain of the vehicle is controlled in accordance with the parameter. The signal is a vehicle speed. The control parameter is set by estimating a vector of accelerations for multiple time windows, calculating a target acceleration, and summing feedforward and feedback values. Each of the multiple time windows has a different length of time. The acceleration vector is estimated as a function of the vehicle speed and a test speed. The target acceleration is calculated by multiplying the acceleration vector by a driving mode vector. The driving mode vector has a coefficient for each of the time windows. The feedforward value is a function of a test cycle and the target acceleration. The feedback value is a function of the test cycle and vehicle speed.

Another embodiment contemplates a method of testing an automotive vehicle. A speed of the vehicle is measured. An acceleration vector is estimated, for multiple time windows, as a function of the measured speed and a test speed. A target acceleration is calculated by multiplying the acceleration vector by a driving mode vector. A target speed, of a driver model, is set as a function of a test cycle, the target acceleration, and the speed. The vehicle is controlled at the target speed.

Another embodiment contemplates a system of testing an automotive vehicle. The system comprises an input, a processor, and an output. The input receives an estimate of vehicle speed. The processor estimates, as functions of the vehicle speed and a test speed, an acceleration vector of accelerations for multiple time windows, calculates a target acceleration by multiplying the acceleration vector by a driving mode vector, and sets a control parameter of a driver model. The driving mode vector has a coefficient for each of the time windows. The processor sets the control parameter as a function of a test cycle, the target acceleration, and the vehicle speed. The output transmits the control parameter.

An advantage of an embodiment is a driver model that calculates a target acceleration as a function of estimated accelerations for multiple time windows having different time lengths. An automated driver using the driver model better follows a test cycle for a vehicle being tested, including for different driving scenarios.

### BRIEF DESCRIPTION OF DRAWINGS

FIG. 1 is a schematic view of automotive vehicle testing employing a driver model.

FIG. 2 is a schematic view of the driver model of FIG. 1.

FIG. 3 is a schematic view of an acceleration estimator module of the driver model of FIG. 2.

### DETAILED DESCRIPTION

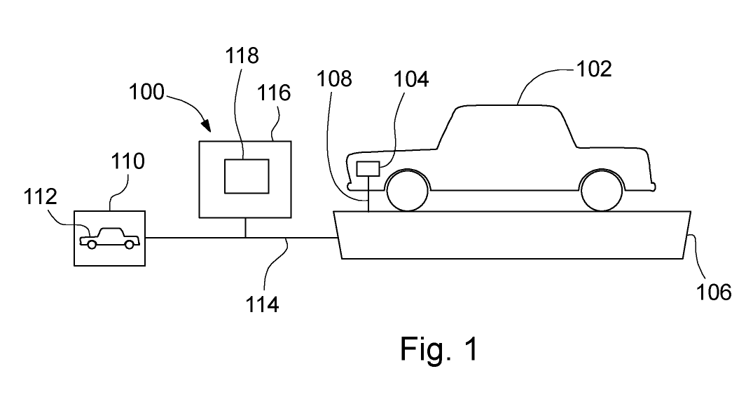

FIG. 1 illustrates a system, indicated generally at 100, for controlling a vehicle 102 during testing. Specifically, the system 100 may control a powertrain 104 of the vehicle 102 during testing. The system 100 may be in communication with a dynamometer test bed 106 with which the vehicle 102 is tested. Control connection 108 connects the dynamometer 106 with the vehicle 102 and allows communication between the system 100 and the vehicle 102. Alternatively, the system 100 may be in communication with a computer 110 upon which the vehicle 102 is tested via a vehicle simulation 112. The vehicle 102 may be tested independently with either the dynamometer 106 or the computer 110 and the system 100 may omit one of the dynamometer 106 or the computer 110.

A data network 114 connects the dynamometer 106 and the computer 110 with a processor 116. The network 114 provides inputs and outputs between the dynamometer 106, computer 110, and processor 116. Alternatively, a single computer may comprise the computer 110 and processor 116. The processor 116 runs a driver model 118.

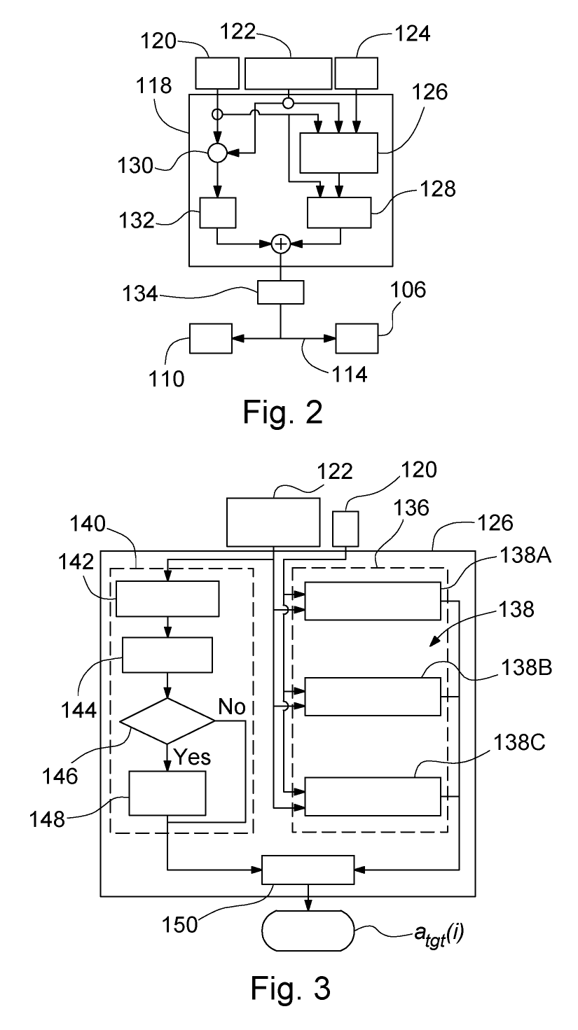

FIG. 2 illustrates the driver model 118. The driver model 118 receives as inputs a test cycle 120, an estimated signal 122, and other inputs 124. The test cycle 120 includes a standard vehicle speed profile such as the United States Environmental Protection Agency (EPA) Federal Test Procedure (FTP), US06 Supplemental Federal Test Procedure, a test procedure of another country, or a user defined speed profile. The estimated signal 122 may be a vehicle speed of the vehicle 102 that is calculated, using known techniques, by integrating measured acceleration. Alternatively, or in addition to, the estimated signal 122 may be the vehicle speed calculated as disclosed in U.S. Pat. No. 9,174,647 to Rose et al., the disclosure of which is hereby incorporated by reference in entirety herein. The estimated signal 122 may also be the vehicle speed as measured by a speed sensor. The other inputs 124 may include adjustments to the driver model 118. The test cycle 120, estimated signal 122, and other inputs 124 are received as inputs to the controller 116 via the network 114.

An acceleration estimator module 126 receives the test cycle 120 and estimated signal 122. The acceleration estimator 126 outputs a target acceleration a_{tgt}(i) that is supplied to a feedforward control 128.

Calculation of the target acceleration a_{tgt}(i) is illustrated in FIG. 3 and will be discussed in detail.

The feedforward control 128, in addition to the target acceleration a_{tgt}(i), also receives the test cycle 120 and calculates a feedforward control value. The feedforward control 128 may be, as is disclosed in U.S. Pat. No. 9,174,647 to Rose et al, a flexible time mapping window based on historical vehicle data and future target speeds—e.g., equations 1-3.

An error calculator 130 also receives the test cycle 120 and the estimated signal 122 to calculate an error amount. For example, the error amount may be a difference between a target signal value from the test cycle 120 and the estimated signal 122. The error amount is output to a feedback control 132. The feedback control 132 may be, as known to those skilled in the art, a PID controller. The feedback control 132 outputs a feedback value.

The feedforward value is adjusted by the feedback value. For example, the feedforward and feedback values may be summed together to set a control parameter 134. For example, the control parameter may be fuel and braking commands for the vehicle 102, or positions of fuel and brake pedals of the vehicle 102, that result in a target speed. The control parameter 134 may also be the target speed for the vehicle 102. The control parameter is output, via the network 114, to the dynamometer 106 and/or computer 110. The powertrain 104 is then controlled in accordance with the parameter 134.

FIG. 3 illustrates the acceleration estimator 126 in detail. The acceleration estimator 126 has a time window module 136 which estimates average acceleration for each of multiple time windows, indicated generally at 138. As defined herein, “multiple time windows” means more than one time window, with each of the time windows being a different length or duration of time. As illustrated, the time window module 136 estimates average acceleration for three time windows: a first average acceleration a₁ for a first time window 138A of, for example, 0.7 seconds, a second average acceleration a₂ for a second time window 138B of, for example, 2.0 seconds, and a third average acceleration a₃ for a third time window 138C of, for example, 5.0 seconds. The time window module 136 may also estimate average acceleration for more or less than three time windows and for greater or lesser time durations. The multiple time windows permit the driver model 118 to notice both instantaneous changes in vehicle speed and any long term trends.

The first, second, and third average accelerations a₁, a₂, and a₃, respectively, are calculated as:

$$\begin{matrix}{a}_{1} = \frac{{V}_{target} ( t + 0.7 ) - {V}_{actual} ( t )}{0.7} , & ( 1 ) \\ {a}_{2} = \frac{{V}_{target} ( t + 2.0 ) - {V}_{actual} ( t )}{2.0} , and & ( 2 ) \\ {a}_{1} = \frac{{V}_{target} ( t + 5.0 ) - {V}_{actual} ( t )}{5.0} , respectively , & ( 3 )\end{matrix}$$

wherein V_{target} are target test speeds from the test cycle 120 and V_{actual} is from the estimated signal 122. The first, second, and third average accelerations a₁, a₂, and a₃, respectively, form an acceleration vector \vec{A}.

The acceleration estimator 126 also has a coefficient module 140 with a driving scenario identifier 142 and a driving mode matrix module 144. The driving scenario identifier 142 identifies, from a plurality of pre-defined driving scenarios, which driving scenario the vehicle 10 is operating in. As a non-limiting example, the vehicle 102 may be operating in normal driving, vehicle launch, stop, or speed bungee driving scenarios. Each of the driving scenarios has an associated driving mode vector of weight coefficients. The coefficients vary for each of the driving scenarios. Each of the driving mode vectors has a coefficient for each of the time windows 138—e.g., if there are three time windows, then there are three coefficients in the associated driving mode vector. Together, the driving mode vectors form a driving mode matrix [DMM] stored in the driving mode matrix module 144. The driving mode matrix [DMM ] may be supplied to the driver model 118, or updated, via the other inputs 124.

The coefficient module 140 also has a mode switch 146 and a mode transition module 148. The scenario identifier 142 also identifies when the driving scenario has changed, for example, from a first or original driving scenario p to a second or destination driving scenario q. When the driving scenario has changed, the mode switch proceeds to the mode transition module 148. The mode transition module 148, over a time transition time window T, transitions the driving mode vector from a first or original driving mode vector \vec{K}ₚ to a second or destination \vec{K}_{q} driving mode vector. Otherwise, when the driving scenario has not changed, the mode switch 146 proceeds to a multiplier 150.

For example, when the driving scenario identifier 142 has identified the first driving scenario p has changed to the second driving scenario q, the mode transition module 148 transitions from the first driving scenario p to the second driving scenario q over the transition time window T. The driving scenario, at a time t=0 of the transition time window T, has the first driving mode vector \vec{K}ₚ and a first or original target acceleration [symbol] \vec{K}ₚ,\vec{A} [symbol] . Subsequently, at a time t=T of the transition time window T, the driving scenario has the second driving mode vector \vec{K}_{q} and a second or destination target acceleration [symbol] \vec{K}_{q},\vec{A} [symbol] . During the transition time window—i.e., 0<t<T, the driving scenario has a transition driving mode vector:

$$\vec{K} ( t ) = ( 1 - \frac{t}{T} ) \cdot {\vec{K}}_{p} + \frac{t}{T} \cdot {\vec{K}}_{q} \qquad ( 4 )$$

and a transition target acceleration is [symbol] \vec{K}(t),\vec{A} [symbol] . That is, during the transition time window T, the first driving mode vector \vec{K}ₚ is reduced by a first amount while the second driving mode vector \vec{K}_{q} is increased by a second amount, wherein the first and second amounts or rates are inversely proportional. The first amount may be a first constant rate and the second amount may be a second constant rate.

The multiplier 150 calculates the target acceleration as a_{tgt}(i) as an inner product of the driving mode matrix [DMM] and the acceleration vector \vec{A}:

$$[ \begin{matrix}{a}_{tgt} ( 1 ) \\ {a}_{tgt} ( 2 ) \\ ⋮ \\ {a}_{tgt} ( n )\end{matrix} ] = [ \begin{matrix}{k}_{1 , 1} & {k}_{1 , 2} & {k}_{1 , 3} \\ {k}_{2 , 1} & {k}_{2 , 2} & {k}_{2 , 3} \\ ⋮ & ⋱ & ⋮ \\ {k}_{n , 1} & {k}_{n , 2} & {k}_{n , 3}\end{matrix} ] \cdot [ \begin{matrix}{a}_{1} \\ {a}_{2} \\ {a}_{3}\end{matrix} ] = [ \begin{matrix}{\vec{K}}_{1} \\ {\vec{K}}_{2} \\ ⋮ \\ {\vec{K}}_{n}\end{matrix} ] \cdot [ \vec{A} ] = [ DMM ] \cdot [ \vec{A} ] . \qquad ( 5 )$$

Only one driving mode can be active at a time because all of the driving scenarios are exclusive. The target acceleration a_{tgt}(i) corresponding to the identified driving scenario is output by the acceleration estimator 126 as the target acceleration a_{tgt}(i).

The target acceleration a_{tgt}(i) for the identified driving scenario is defined as:

$$\begin{matrix}{a}_{tgt} ( i ) = {k}_{i , 1} \times {a}_{1} + {k}_{i , 2} \times {a}_{2} + {k}_{i , 3} \times {a}_{3} \\ = [ {k}_{i , 1} , {k}_{i , 2} , {k}_{i , 3} ] \cdot [ \begin{matrix}{a}_{1} \\ {a}_{2} \\ {a}_{3}\end{matrix} ] \\ = 〈 {\vec{K}}_{i} , \vec{A} 〉 .\end{matrix} \qquad ( 6 )$$

As is evident from EQN. 6, the target acceleration a_{tgt}(i) is a weighted mean of multiple estimated accelerations. This allows the target acceleration a_{tgt}(i) to balance short term changes with long term trends.

While certain embodiments of the present invention have been described in detail, those familiar with the art to which this invention relates will recognize various alternative designs and embodiments for practicing the invention as defined by the following claims.

What is claimed is:

1. A method of testing an automotive vehicle comprising:
estimating a vehicle signal, wherein the signal is a vehicle speed;
setting a control parameter of a driver model for the vehicle by
estimating, as functions of the vehicle speed and a test speed, a vector of accelerations for multiple time windows, wherein each of the time windows has a different length of time;
calculating a target acceleration by multiplying the acceleration vector by a driving mode vector, the driving mode vector having a coefficient for each of the time windows;
summing feedforward and feedback values, wherein the feedforward value is a function of a test cycle and the target acceleration and the feedback value is a function of the test cycle and vehicle speed;
controlling a powertrain of the vehicle in accordance with the parameter.

2. The method of claim 1 wherein the parameter results in a target speed for the vehicle.

3. The method of claim 1 wherein the powertrain is controlled by setting fuel and braking commands for the vehicle.

4. The method of claim 1 wherein the powertrain is controlled in a simulation of the vehicle run on a computer.

5. The method of claim 1 wherein the feedforward value is calculated by a time mapping window based on historical vehicle data and future target speeds.

6. The method of claim 1 wherein the feedback value is calculated by a PID controller.

7. The method of claim 1 further comprising:
identifying a driving scenario;
selecting the driving mode vector as a function of the driving scenario.

8. The method of claim 1 further comprising:
identifying when a first driving scenario has changed to a second driving scenario, wherein the first driving scenario has a first driving mode vector, the second driving scenario has a second driving mode vector, and the driving mode vector is a combination of the first and second driving mode vectors.

9. The method of claim 8 wherein the driving mode vector is a sum of the first and second driving mode vectors and, during a transition time window, the first driving mode vector is reduced by a first amount that is inversely proportional to a second amount by which the second driving mode vector is increased.

10. A method of testing an automotive vehicle comprising:
measuring a speed of the vehicle;
estimating an acceleration vector, for multiple time windows, as a function of the speed and a test speed;
calculating a target acceleration by multiplying the acceleration vector by a driving mode vector;
setting a target speed, of a driver model, as a function of a test cycle, the target acceleration, and the speed;
controlling the vehicle at the target speed.

11. The method of claim 10 wherein the vehicle is controlled in a simulation of the vehicle run on a computer.

12. The method of claim 10 further comprising:
identifying a driving scenario;
selecting, as a function of the driving scenario, the driving mode vector from a driving mode matrix.

13. The method of claim 10 further comprising:
identifying when a first driving scenario has changed to a second driving scenario, wherein the first driving scenario has a first driving mode vector and the second driving scenario has a second driving mode vector;
summing the first and second driving mode vectors to form the driving mode vector, wherein, during a transition time window, the first driving mode vector is reduced at a first rate that is inversely proportional to a second rate at which the second driving mode vector is increased.

14. A system of testing an automotive vehicle comprising:
an input receiving an estimate of vehicle speed;
a processor
estimating, as functions of the vehicle speed and a test speed, an acceleration vector of accelerations for multiple time windows;
calculating a target acceleration by multiplying the acceleration vector by a driving mode vector, the driving mode vector having a coefficient for each of the time windows;
setting a control parameter, of a driver model, as a function of a test cycle, the target acceleration, and the vehicle speed;
an output transmitting the control parameter.

15. The system of claim 14 further comprising:
a dynamometer test bed upon which the vehicle is tested, wherein the test bed estimates and transmits the vehicle speed and receives the control parameter.

16. The system of claim 14 further comprising:
a vehicle simulation run on a computer, wherein the simulation estimates and transmits the vehicle speed and receives the control parameter, wherein the simulation is run in accordance with the control parameter.

17. The system of claim 14 further comprising:
a powertrain of the vehicle receiving and being controlled per the control parameter.

18. The system of claim 14 wherein the control parameter results in a target speed for the vehicle.

19. The system of claim 14 wherein the processor identifies a driving scenario and selects the driving mode vector from a driving mode matrix as a function of the driving scenario.

20. The system of claim 14 wherein the processor identifies when a first driving scenario has changed to a second driving scenario, wherein the first driving scenario has a first driving mode vector, the second driving scenario has a second driving mode vector, and the first and second driving mode vectors are summed to form the driving mode vector, wherein, during a transition time window, the first driving mode vector is reduced at a first rate that is inversely proportional to a second rate at which the second driving mode vector is increased.
